(19) United States
(12) Patent Application Publication
(10) Pub. No.: US 2005/0138221 A1
(43) Pub. Date: Jun. 23, 2005

(54) Handling redundant paths among devices

(75) Inventor: Nathan E. Marushak, Gilbert, AZ (US)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/746,657

(22) Filed: Dec. 23, 2003

(51) Int. Cl. G06F 3/00

(52) U.S. Cl. 710/1; 709/220

(57) ABSTRACT

Provided are a method, system, and article of manufacture for initiating a discovery operation to discover end devices and intermediary devices. In response to discovering one device during the discovery operation, a determination is made as whether there are redundant paths to the discovered device. One intermediary device is selected to provide one path to the discovered device in response to determining redundant paths to the discovered device. Commands are sent to cause a configuration where the selected intermediary device is configured to provide the path to the discovered device and the path to the discovered device other than through the selected intermediary device is disabled.

### BACKGROUND

1. Field

The embodiments relate to handling redundant paths among devices.

2. Description of the Related Art

An adaptor or multi-channel protocol controller enables a device coupled to the adaptor to communicate with one or more connected end devices over a connection according to a storage interconnect architecture, also known as a hardware interface, where a storage interconnect architecture defines a standard way to communicate and recognize such communications, such as Serial Attached Small Computer System Interface (SCSI) (SAS), Serial Advanced Technology Attachment (SATA), Fibre Channel, etc. Further details on the SAS architecture for devices and expanders is described in the technology specification “Information Technology—Serial Attached SCSI (SAS)”, reference no. ISO/IEC 14776-150:200x and ANSI INCITS.***:200x PHY layer (Jul. 9, 2003), published by ANSI and further details on the SATA architecture are described in the technology specification “Serial ATA: High Speed Serialized AT Attachment” Rev. 1.0A (January 2003).

Devices may communicate through a cable or through etched paths on a printed circuit board when the devices are embedded on the printed circuit board. These storage interconnect architectures allow a device to maintain one or more connections with end devices through a direct connection to the end device or through one or more expanders. In the SAS/SATA architecture, a SAS port is comprised of one or more SAS PHYs, where each SAS PHY interfaces a physical layer, i.e., the physical interface or connection, and a SAS link layer having multiple protocol link layer. Communications from the SAS PHYs in a port are processed by the transport layers for that port. There is one transport layer for each SAS port to interface with each type of application layer supported by the port. A “PHY” as defined in the SAS protocol is a device object that is used to interface to other devices and a physical interface.

An expander is a device that facilitates communication and provides for routing among multiple SAS devices, where multiple SAS devices and additional expanders connect to the ports on the expander, where each port has one or more SAS PHYs and corresponding physical interfaces. The expander also extends the distance of the connection between SAS devices. With an expander, a device connecting to a SAS PHY on the expander may be routed to another expander PHY connected to a SAS device. Further details on the SAS architecture for devices and expanders is described in the technology specification “Information Technology—Serial Attached SCSI (SAS)”, reference no. ISO/IEC 14776-150:200x and ANSI INCITS.***:200x PHY layer (Jul. 9, 2003), published by ANSI, which is referred to herein as the “SAS Specification”.

A port in an adaptor or expander contains one or more PHYs. Ports in a device are associated with PHYs based on the configuration that occurs during an identification transmission. An identification transmission are those one or more transmissions a device initiates to inform a connected device of information on the interface. A port is assigned one or more PHYs within a device for those PHYs within that device that are configured to use the same SAS address during the identification sequence and that connect to attached PHYs that also transmit the same address during the identification sequence. A wide port has multiple PHYs and a narrow port has only one PHY. A wide link comprises the set of physical links that connect the PHYs of a wide port to the corresponding PHYs in the corresponding remote wide port and a narrow link is the physical link that attaches a narrow port to a corresponding remote narrow port.

On an initiator device including SAS ports, a domain comprises all devices that can be reached through an initiator port, where the port may connect to multiple target devices through one or more expanders or directly. A routing loop occurs if at least two paths are available to a single SAS address in a single domain, so that there are multiple paths to the same device in the same domain, i.e., accessible through the same initiator port. The SAS specification provides that if a routing loop is detected, the loop may be broken by disabling all the expander PHYs attached to that target device except the expander PHY with the lowest PHY identifier in the expander device with the lowest SAS address.

### BRIEF DESCRIPTION OF THE DRAWINGS

Referring now to the drawings in which like reference numbers represent corresponding parts throughout:

FIGS. 1 and 2 illustrate a system and adaptor in accordance with embodiments;

FIG. 3 illustrates an architecture of connected devices;

FIGS. 4, 5, and 6 illustrate operations implemented in the adaptor of FIGS. 1 and 2 to handle a situation where there are multiple paths to a single device in the same domain; and

FIG. 7 illustrates an architecture that may be used with the described embodiments.

### DETAILED DESCRIPTION

In the following description, reference is made to the accompanying drawings which form a part hereof and which illustrate several embodiments. It is understood that other embodiments may be utilized and structural and operational changes may be made.

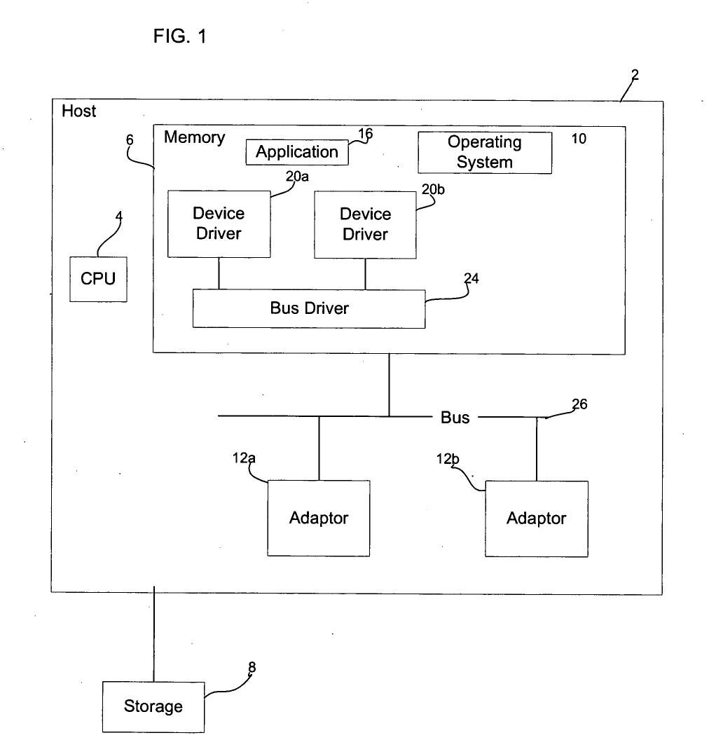

FIG. 1 illustrates a computing environment in which embodiments may be implemented. A host system 2 includes one or more central processing units (CPU) 4 (only one is shown), a volatile memory 6, non-volatile storage 8, an operating system 10, and adaptors 12a, 12b which includes physical interfaces to connect with remote devices, comprising end devices, switches, expanders, storage devices, servers, etc. An application program 16 further executes in memory 6 and is capable of transmitting and receiving frames via one of the adaptors 12a, 12b. The host 2 may comprise any computing device known in the art, such as a mainframe, server, personal computer, workstation, laptop, handheld computer, telephony device, network appliance, virtualization device, storage controller, etc. Various CPUs 4 and operating system 10 known in the art may be used. Programs and data in memory 6 may be swapped into storage 8 as part of memory management operations.

The operating system 10 may load a device driver 20a and 20b for each storage interface supported in the adaptor 12 to enable communication with a device communicating using the same supported storage interface and also load a bus interface 24, such as a Peripheral Component Interconnect (PCI) interface, to enable communication with a bus 26. The operating system 10 may load device drivers 20a and 20b supported by the adaptors 12a, 12b upon detecting the presence of the adaptors 12a, 12b, which may occur during initialization or dynamically, such as the case with plug-and-play device initialization. In the embodiment of FIG. 1, the operating system 10 loads two device drivers 20a and 20b. For instance, the device drivers 20a and 20b may support the SAS and SATA storage interfaces, i.e., interconnect architectures. Additional or fewer device drivers may be loaded based on the number of storage interfaces the adaptors 12a and 12b supports.

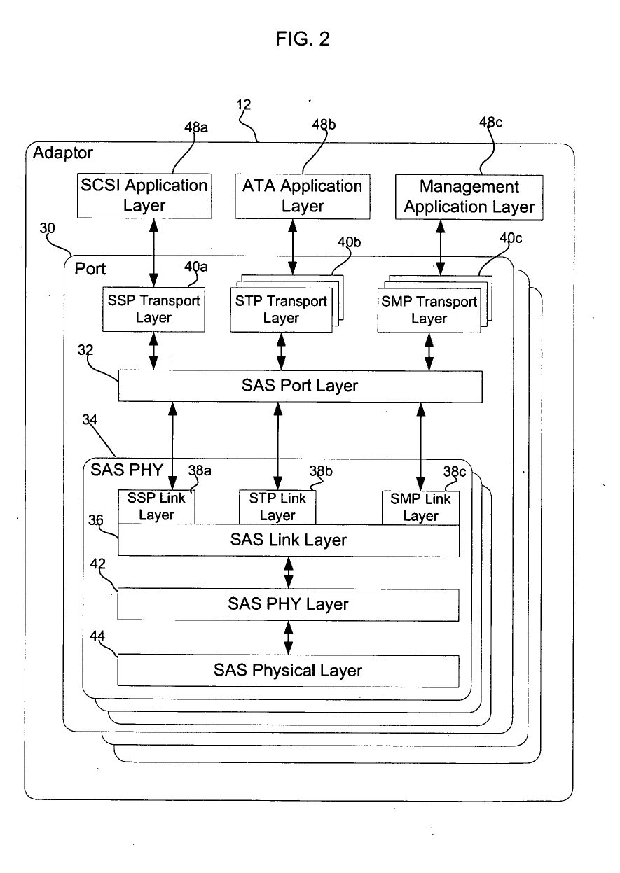

FIG. 2 illustrates an embodiment of an adaptor 12, which may comprise the adaptors 12a, 12b. FIG. 2 additionally illustrates a configuration that may be used in any SAS device, including a SAS expander, initiator, target, etc. Each SAS device includes one or more ports 30, where each port 30 contains a port layer 32 that interfaces with one or more SAS PHYs 34. Each PHY includes a link layer 36 having one or more protocol link layers. FIG. 2 shows three protocol link layers, including a Serial SCSI Protocol (SSP) link layer 38a to process SSP frames, a Serial Tunneling Protocol. (STP) layer 38b, a Serial Management Protocol (SMP) layer 38c, which in turn interface through port layer 32 with their respective transport layers, a SSP transport layer 40a, a STP transport layer 40b, and an SMP transport layer 40c.

Each PHY 34 for port 30 further includes a SAS PHY layer 42 and a physical layer 44. The physical layer 44 comprises the physical interface, including the transmitter and receiver circuitry, paths, and connectors. As shown, the physical layer 44 is coupled to the PHY layer 42, where the PHY layer 42 provides for an encoding scheme, such as 8b10b to translate bits, and a clocking mechanism, such as a phased lock loop (PLL), to convert data between a serial and parallel format. The PHY layer 32a, 32b . . . 32n may include a serial-to-parallel converter to perform the serial-to-parallel conversion and a phased lock loop (PLL) to track the incoming data and provide the data clock of the incoming data to the serial-to-parallel converter to use when performing the conversion. Data is received at the adaptor 12 in a serial format, and is converted by the SAS PHY layer 42 to the parallel format for transmission within the adaptor 12. The SAS PHY layer 42 further provides for error detection, bit shift and amplitude reduction, and the out-of-band (OOB) signaling to establish an operational link with another SAS PHY in another device, speed negotiation with the PHY in the external device transmitting data to adaptor 12, etc. The layers may be implemented as program components executed from memory and/or implemented in hardware.

In the embodiments of FIG. 2, there is one protocol transport layer 40a, 40b, and 40c to interface with each type of application layer 48a, 48b, 48c in the application layer 50. The application layer 50 may be supported in the adaptor 12 or host system 2 and provides network services to the end users. For instance, the SSP transport layer 46a interfaces with a SCSI application layer 48a, the STP transport layer 46c interfaces with an Advanced Technology Attachment (ATA) application layer 48b, and the SMP transport layer 46d interfaces with a management application layer 48c)”. Further details of the ATA technology are described in the publication “Information Technology—AT Attachment with Packet Interface-6 (ATA/ATAPI-6)”, reference no. ANSI INCITS 361-2002 (September, 2002). Further details on the operations of the physical layer, PHY layer, link layer, port layer, transport layer, and application layer and components implementing such layers described herein are found in the SAS Specification, cited above.

An adaptor 12 may further have one or more unique domain addresses, where different ports in an adaptor 12 can be organized into different domains or devices. The SAS address of a PHY may comprise the SAS address of the port to which the PHY is assigned and that port SAS address is used to identify and address the PHY to external devices. A port may be uniquely identified by the SAS address assigned to that port and the SAS address of the PHYs to which the PHYs in the port connect. An interface address comprises an address assigned to an interface, where an interface may comprise a PHY, a logical interface and/or a physical interface, etc., such that an interface provides a connection to another interface which may be on a remote device.

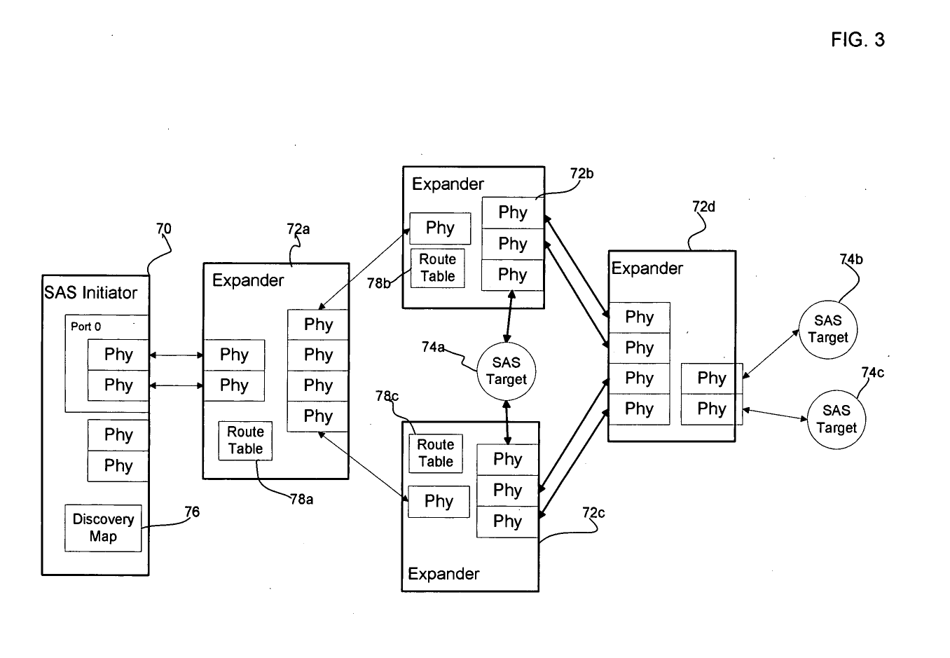

FIG. 3 illustrates an example of a configuration between an initiator 70 having at least one ports 0, expanders 72a, 72b, 72c, and 72d and target devices 74a, 74b, and 74c, which are all in the domain of port 0 of the initiator 70. For instance, the initiator 70 may comprise an adaptor in a server and the target devices 74a, 74b, 74c, 74d may comprise storage devices. In the example of FIG. 3, a routing loop exists to target devices 74a, 74b and 74c because there are multiple paths in the domain of port 0 to target devices 74a, 74b, and 74c comprising the paths through expanders 72a and 72b and expanders 72a and 72c to target device 74a and the paths through expanders 72a, 72b, an 72d and expanders 72a, 72c, and 72d to target devices 74b and 74c. The initiator 70 includes a discovery map 76 providing all the devices in the domain for each port on the initiator 70. Expanders 72a, 72b, and 72c include a route table 78a, 78b, and 78c respectively, providing an association of the expander PHY identifiers and the SAS address of the target end devices that may be accessed through the expander PHY. In the SAS architecture routing loops are undesirable because they may cause mis-routing of requests.

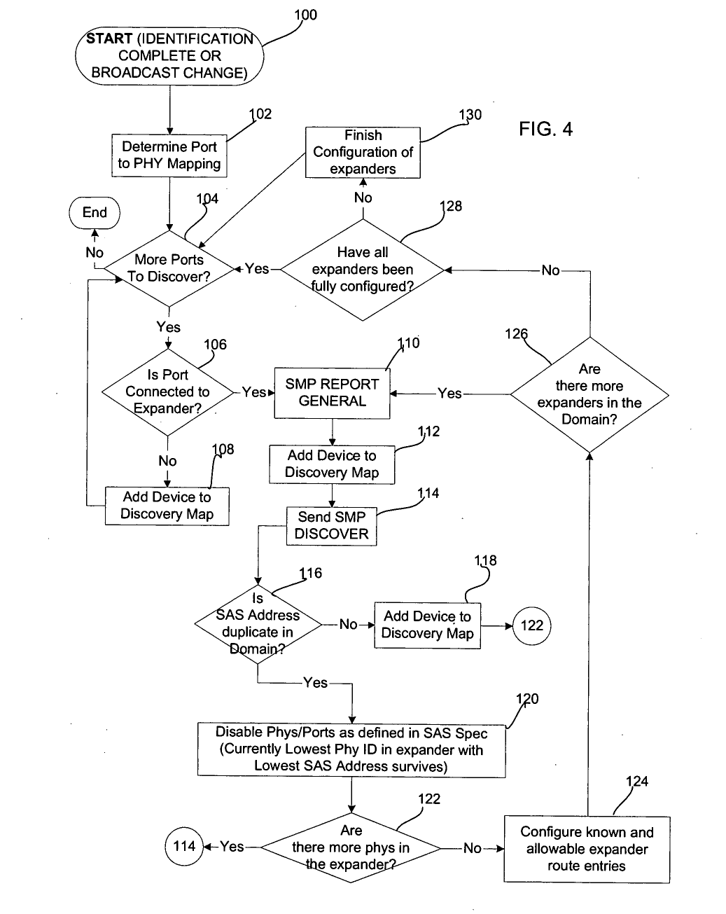

FIG. 4 illustrates an embodiment of operations performed by the initiator 70 to configure the devices in a domain to avoid configuring a routing loop, such as shown in FIG. 3. The operations shown in FIG. 4 may be implemented in the port layer 30 of the initiator 70 port for which the configuration is being performed. At block 100, the initiator 70 begins initialization to discover and configure devices in the domain of a specified port, e.g., port 0, after the identification is complete or a change is broadcasted. During identification, the initiator 70 determines all attached PHYs to the PHYs in the initiator ports. The initiator 70 determines (at block 102) the port to PHY mapping for the initiator 70. If (at block 104) all ports have been subject to discovery, then control ends; otherwise, if there are initiator 70 ports that have not yet been subject to discovery, then a determination is made (at block 106) whether one PHY in one undiscovered port is attached to an expander. Discovery may be performed with respect to only one PHY in a port because all PHYs in a port connect to the same port in a remote device. If (at block 106) the port is not connected to an expander, but an end device, then the SAS address of that device is added (at block 108) to the discovery map 76 for that domain of the initiator 70 port being discovered.

If (at block 106) the port is attached to an expander, e.g., 72a, then the initiator, e.g., 70, sends (at block 110) a request to obtain information about the attached expander, such as an SMP report general, to the attached expander and adds (at block 112) information on the attached expander to the discovery map 76. The initiator 70 further sends (at block 114) a discovery request, such as an SMP discovery request, to the expander to determine the SAS address of expanders, e.g., 72b, 72c, or end devices attached to the expander added to the discovery map 76. If (at block 116) the SAS address of the expander added to the discovery map 76 is not a duplicate to any other expander in the domain already included in the discovery map 76, then the SAS address of the expander is added (at block 118) to the discovery map 76; otherwise, the initiator 70 disables (at block 120) the port and its PHYs subject to the discovery operation. In certain embodiments, the initiator 70 may disable the port/PHY on the intermediary expander, e.g., 72a, connecting to the expander port/PHY having the duplicate address e.g., 72b, 72c. Alternatively, the initiator 70 may disable the port/PHY having the duplicate address, e.g., 72d. The path that is disabled may include the path having the duplicate expander port/PHY having the lowest PHY identifier in the intermediary expander having the lowest expander SAS address. Alternative techniques may be used to select a route/duplicate expander to disable and perform the disabling. For instance, the route may be disabled by disabling the port on one expander providing the duplicate paths and not disabling other PHYs/ports.

If (at block 122) there are more PHYs in the discovered expander, then control proceeds back to block 114 to discover any further expanders, e.g., 72b, 72c, and/or end devices attached to the additional PHYs in the expander, e.g., 72a. Otherwise, if there are no more PHYs on the expander to discover, then the initiator 70 configures (at block 124) the known and allowable expander route entries that conform to configuration rules, such as the rule requiring no duplicate paths to a SAS device in the same domain. In certain embodiments, the initiator 70 may perform a level ordered traversal or breadth first discovery, where all devices at a level are discovered before proceeding to discover and configure paths for the devices at a next level. After configuring all the routes for an expander and expanders connected to that expander that satisfy the discovery rules so as not to have duplicate addresses for an expander, a determination is made (at block 126) as to whether there are further expanders in the domain of the port being discovered. The initiator 70 would learn of further expanders, e.g., 72b, 72c, 72d, in response to the discovery request sent to the expander just discovered. If (at block 126) there are further expanders to discover in the domain, then control proceeds back to block 110 to perform discovery with respect to that additional expander, e.g., 72b, 72c, 72d. Otherwise, if (at block 126) there are no more expanders in the domain to discover, then a determination is made (at block 128) whether all expanders have been fully configured. If not, then the configuration of the expanders is completed (at block 130). From the yes branch of block 128 or block 130, control proceeds back to block 104 to perform discovery with respect to any further ports in the initiator 70.

In the embodiment of FIG. 4, actions are performed to enable or disable paths to ensure that there is only a single path to an end device during the discovery process. FIG. 4 disables expander PHYs/ports providing duplicate paths as each expander is discovered to configure the routes in a single pass.

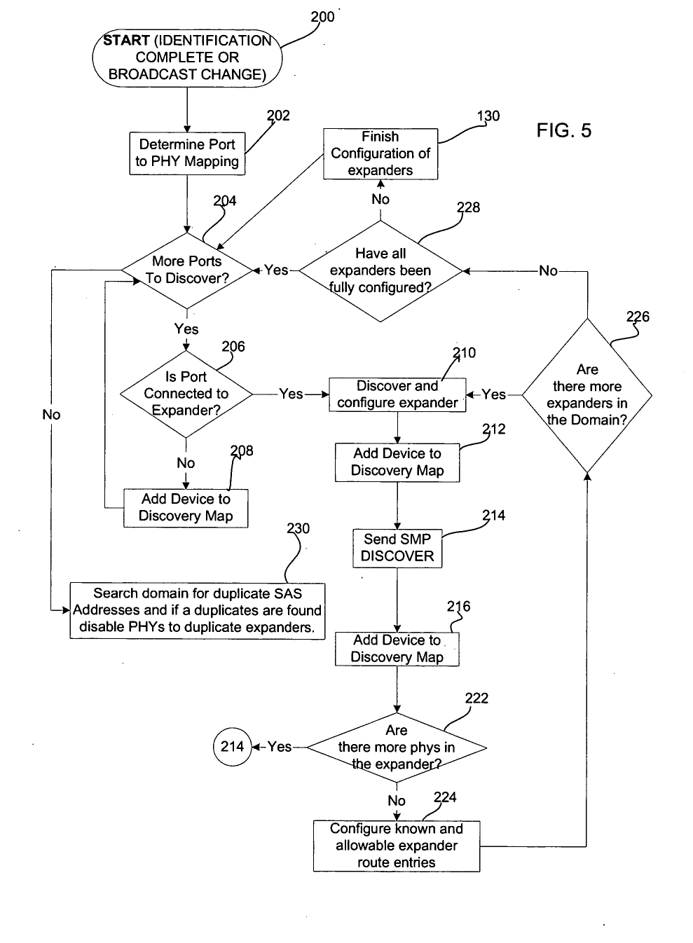

FIG. 5 illustrates an alternative embodiment for configuring devices in a domain so that certain paths are disabled to the end device or same SAS address. The operations shown in FIG. 5 may be implemented in the port layer 30 of the initiator 70 port for which the configuration is being performed. At block 200, the initiator 70 begins initialization to discover and configure devices in the domain of a specified port, e.g., port 0, after the identification is complete or a change is broadcasted. During identification, the initiator 70 determines all attached PHYs to the PHYs in the initiator ports. The initiator 70 determines (at block 202) the port to PHY mapping for the initiator 70. If (at block 204) there are initiator 70 ports that have not yet been subjected to discovery, then a determination is made (at block 206) whether one PHY in one undiscovered port is attached to an expander. If (at block 208) the port is not connected to an expander, but an end device, then the SAS address of that device is added (at block 208) to the discovery map 76 for that domain of the initiator 70 port being discovered.

If (at block 206) the port is attached to an expander, e.g., 72a, then the initiator, e.g., 70, discovers and configures (at block 210) the attached expander and adds (at block 212) information on the attached expander to the discovery map 76. The initiator 70 further sends (at block 214) a discovery request, such as an SMP discovery request, to the expander to determine the SAS address of expanders, e.g., 72b, 72c, or end devices attached to the expander added to the discovery map 76. The expander or end device discovered in response to the SMP discover request sent at block 214 is added (at block 216) to the discovery map 76. If (at block 222) there are more PHYs in the discovered expander, then control proceeds back to block 214 to discover any further expanders, e.g., 72b, 72c, and/or end devices attached to the additional PHYs in the expander, e.g., 72a, added to the map that have not been subject to discovery. Otherwise, if there are no more PHYs on the expander to discover, then the initiator 70 configures (at block 224) the known expander route entries. After configuring all the routes for the expander and expanders connected to that expander that satisfy the discovery rules so as not to have duplicate addresses for an expander, a determination is made (at block 226) as to whether there are further expanders in the domain of the port being discovered. The initiator 70 would learn of further expanders, e.g., 72b, 72c, 72d, in response to the discovery request sent to the expander just discovered. As discussed, in certain embodiments, the initiator 70 may perform a level ordered traversal or breadth first discovery, where all devices at a level are discovered before proceeding to discover and configure paths for the end devices and expanders at a next level of devices. If (at block 226) there are further expanders to discover in the domain, then control proceeds back to block 210 to discover and configure any further expander, e.g., 72b, 72c, 72d. Otherwise, if (at block 226) there are no more expanders in the domain to discover, then a determination is made (at block 228) whether all expanders have been fully configured. If not, then the configuration of the expanders is completed (at block 230). From the yes branch of block 228 or block 230, control proceeds back to block 204 to perform discovery with respect to any further ports in the initiator 70.

After discovering and configuring expanders at all the ports, the initiator 70 searches (at block 230) each domain for expanders having duplicate SAS addresses, e.g., expanders 72b or 72c. If duplicates are found, selected expander PHYs/ports are disabled. As discussed, in certain embodiments, the initiator 70 may disable the ports connecting to the expander having the duplicate address, which may involve disabling all but the PHY/port having a lowest PHY identifier in an expander having the lowest expander SAS address. Alternative techniques may be used to select a route/duplicate expander to disable and perform the disabling.

With the operations of FIG. 5, redundant paths are removed after all the devices are discovered.

In the embodiments of FIGS. 4 and 5, when detecting redundant paths, an administrator may be alerted to the problem to allow the administrator to address the problem, or the redundant paths may be removed automatically as described above.

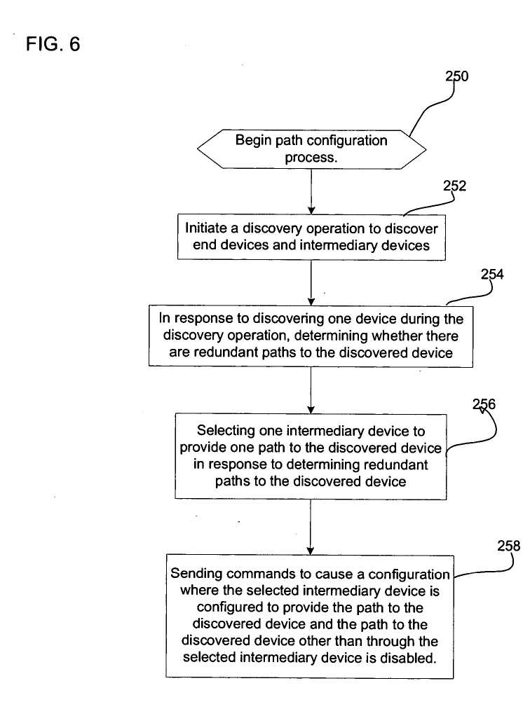

FIG. 6 illustrates an additional embodiment to discover and configure devices. At block 250, the path configuration process begins. A path may comprise a connection from one device in a network topology, such as an initiator device, to another end device, including any intermediary devices therebetween. The end device may comprise a communication adaptor, such as a SAS adaptor, on a storage unit, server or other network device, and the intermediary devices may comprise devices that extend the length and number of connections from the initiator device to the end device. In SAS embodiments, the intermediary device may comprise a SAS expander. At block 252, the end devices and intermediary devices are discovered, where the devices discovered may be in the domain of a port on an initiator device. In response to discovering one device during the discovery operation, a determination is made (at block 254) as to whether there are redundant paths to the discovered device (end or intermediary device). The determination may occur during a discovery operation from the initiator to discover all connected devices in a domain. One intermediary device is selected (at block 256) to provide one path to the discovered device, where the discovered device may comprise an end device or intermediary device to which the redundant paths lead. The operation of selecting one intermediary device may comprise determining one interface in one intermediary device having a lowest device address, where an interface may comprise a single interface providing a connection from a device to a remote device, such as a PHY, or a port to which a plurality of interfaces, e.g., PHYs, are assigned.

At block 258, commands are sent to cause a configuration where the selected intermediary device is configured as the path to the connected device and the path to the discovered device other than through the selected intermediary device other than the selected intermediary device is disabled. In certain embodiments, the commands that cause the disabling of the at least one path through the at least one intermediary device other than the selected intermediary device further comprise determining at least one interface on the at least one intermediary device coupled to the path to the discovered device to disable and sending a command to disable the determined interface.

In still further embodiments, sending the commands to cause the configuration to disable the at least one path to the discovered device comprises disabling at least one interface on the intermediary device other than the selected device that connects to one corresponding interface on the discovered device. In alternative embodiments, sending the commands to cause the configuration to disable the at least one path to the discovered device comprises disabling at least one interface on the discovered device that connects to the intermediary device other than the selected intermediary device.

In certain embodiments, the devices may comprise SAS devices, the intermediary devices may comprise SAS expanders, and wherein redundant paths may occur when there are multiple paths to a same SAS address in a same domain.

In alternative embodiments, a discovery map indicating end and intermediary devices discovered as accessible is generated and the generated discovery map is processed to determine one or more devices to which there are redundant paths. For each determined device to which there are redundant paths, one intermediary device is selected to provide one path to the determined device. Commands are sent to cause a configuration where the selected intermediary device is configured as the path to the determined device and the at least one path to the determined device through at least one intermediary device other than the selected intermediary device is disabled.

Described embodiments provide techniques to detect redundant paths through intermediary devices, such as SAS expanders, during device discovery so that only one path to a device is configured and any possible redundant paths to the same target device are disabled.

### Additional Embodiment Details

The described embodiments may be implemented as a method, apparatus or article of manufacture using programming and/or engineering techniques to produce software, firmware, hardware, or any combination thereof. The term “article of manufacture” and “circuitry” as used herein refers to a state machine, code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. When the code or logic is executed by a processor, the circuitry may include the medium including the code or logic as well as the processor that executes the code loaded from the medium. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration, and that the article of manufacture may comprise any information bearing medium known in the art. Additionally, the devices, adaptors, etc., may be implemented in one or more integrated circuits on the adaptor or on the motherboard.

Additionally, the expander, PHYs, and protocol engines may be implemented in one or more integrated circuits on the adaptor or on the motherboard.

In the described embodiments, layers were shown as operating within specific components, such as the expander and devices, such as the initiator and target end devices. In alternative implementations, layers may be implemented in a manner different than shown.

In described embodiments, if there are redundant paths through multiple intermediary devices to one port/PHY, then the disabled one or more paths comprise all one or more redundant paths but the path through the port/PHY on the intermediary expander having the lowest PHY identifier in the intermediary expander having the lowest SAS address. In alternative embodiments, different techniques may be used to select expanders and PHYs providing redundant paths to a device to disable or not configure than selecting all but the PHY/Port with the lowest PHY identifier in the intermediary expander having the lowest SAS address.

In certain implementations, the device driver and network adaptor embodiments may be included in a computer system including a storage controller, such as a SCSI, Redundant Array of Independent Disk (RAID), etc., controller, that manages access to a non-volatile storage device, such as a magnetic disk drive, tape media, optical disk, etc. In alternative implementations, the network adaptor embodiments may be included in a system that does not include a storage controller, such as certain hubs and switches.

In described embodiments, the storage interfaces supported by the adaptors comprised SATA and SAS. In additional embodiments, other storage interfaces may be supported. Additionally, the adaptor was described as supporting certain transport protocols, e.g. SSP, STP, and SMP. In further implementations, the adaptor may support additional transport protocols used for transmissions with the supported storage interfaces.

The illustrated operations of FIGS. 4 and 5 show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The adaptor 12 may be implemented on a network card, such as a Peripheral Component Interconnect (PCI) card or some other I/O card, or on integrated circuit components mounted on a system motherboard or backplane.

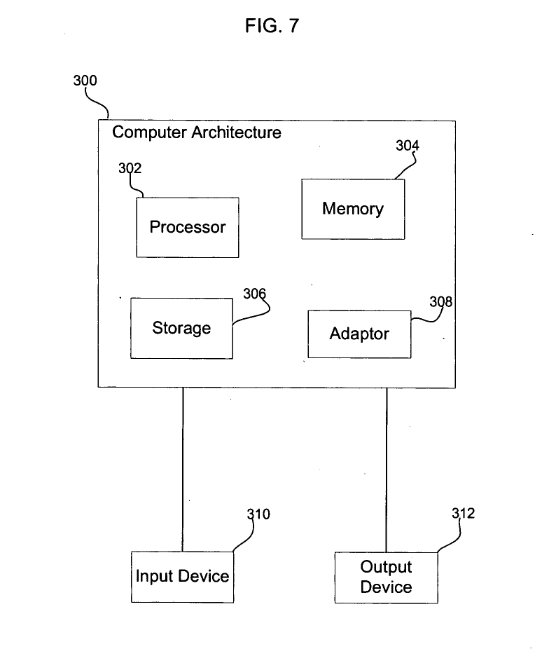

FIG. 7 illustrates one implementation of a computer architecture 300 of the components that may include the initiators. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes an adaptor as described above with respect to FIGS. 1-7 to enable a point-to-point connection with an end device, such as a disk drive assembly. As discussed, certain of the devices may have multiple network cards. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The foregoing description of various embodiments has been presented for the purposes of illustration and description. It is not intended to be exhaustive or to limit the claims to the precise form disclosed. Many modifications and variations are possible in light of the above teaching.

1. A method, comprising:
initiating a discovery operation to discover end devices and intermediary devices;
in response to discovering one device during the discovery operation, determining whether there are redundant paths to the discovered device;
selecting one intermediary device to provide one path to the discovered device in response to determining redundant paths to the discovered device; and
sending commands to cause a configuration where the selected intermediary device is configured to provide the path to the connected device and the path to the discovered device other than through the selected intermediary device is disabled.

2. The method of claim 1, wherein the discovered device comprises an end device or an intermediary device.

3. The method of claim 1, wherein the commands that cause the disabling of the at least one path further comprise:
determining at least one interface on the intermediary device providing the redundant path to disable; and
sending a command to disable the determined interface.

4. The method of claim 3, wherein selecting one intermediary device comprises determining one interface in one intermediary device having a lowest device address.

5. The method of claim 1, wherein determining whether there are redundant paths to the discovered device during the discovery operation comprises:
determining whether an address of the discovered device matches one address of a previously discovered device; and
adding information on the path through the selected intermediary device to the discovery device to a discovery map.

6. The method of claim 1, wherein sending the commands to cause the configuration to disable the path to the discovered device comprises:
disabling at least one interface on the intermediary device providing the redundant path to disable that connects to one corresponding interface on the discovered device.

7. The method of claim 1, wherein sending the commands to cause the configuration to disable the to the discovered device comprises:
disabling at least one interface on the discovered device that connects to the intermediary device providing the redundant path to disable.

8. The method of claim 1, wherein the devices comprise SAS devices, the intermediary devices comprise SAS expanders, and wherein redundant paths occur when there are multiple paths to a same SAS address in a same domain.

9. A method, comprising:
generating a discovery map indicating discovered end and intermediary devices;
processing the generated discovery map to determine one or more devices to which there are redundant paths;
for each determined device to which there are redundant paths, selecting one intermediary device to provide one path to the determined device; and
sending commands to cause a configuration where the selected intermediary device is configured as the path to the determined device and the at least one path to the determined device through at least one intermediary device other than the selected intermediary device is disabled.

10. The method of claim 9, wherein processing the generated discovery map to determine the devices to which there are redundant paths comprises determining duplicate instances of one address, wherein duplicate instances of one address indicate redundant paths through intermediary devices to one device.

11. A system coupled to a plurality of devices, including at least one end device and at least one intermediary device, comprising:
circuitry capable of causing operations to be performed, the operations comprising:
(i) initiating a discovery operation to discover end devices and intermediary devices;
(ii) in response to discovering one device during the discovery operation, determining whether there are redundant paths to the discovered device;
(iii) selecting one intermediary device to provide one path to the discovered device in response to determining redundant paths to the discovered device; and
(iv) sending commands to cause a configuration where the selected intermediary device is configured to provide the path to the discovered device and the path to the discovered device other than through the selected intermediary device is disabled.

12. The system of claim 11, wherein the discovered device comprises an end device or an intermediary device.

13. The system of claim 11, wherein the commands that cause the disabling of the at least one path further cause operations comprising:
determining at least one interface on the intermediary device providing the redundant path to disable; and
sending a command to disable the determined interface.

14. The system of claim 13, wherein selecting one intermediary device comprises determining one interface in one intermediary device having a lowest device address.

15. The system of claim 11, wherein determining whether there are redundant paths to the discovered device during the discovery operation comprises:
determining whether an address of the discovered device matches one address of a previously discovered device; and
adding information on the path through the selected intermediary device to the discovery device to a discovery map.

16. The system of claim 11, wherein sending the commands to cause the configuration to disable the path to the discovered device comprises:
disabling at least one interface on the intermediary device providing the redundant path to disable that connects to one corresponding interface on the discovered device.

17. The system of claim 10, wherein sending the commands to cause the configuration to disable the to the discovered device comprises:
disabling at least one interface on the discovered device that connects to the intermediary device providing the redundant path to disable.

18. The system of claim 10, wherein the devices comprise SAS devices, the intermediary devices comprise SAS expanders, and wherein redundant paths occur when there are multiple paths to a same SAS address in a same domain.

19. A system coupled to a plurality of devices, including at least one end device and at least one intermediary device, comprising:
circuitry capable of causing operations to be performed, the operations comprising:
(i) generating a discovery map indicating accessible end and intermediary devices;
(ii) processing the generated discovery map to determine one or more devices to which there are redundant paths;
(iii) for each determined device to which there are redundant paths, selecting one intermediary device to provide one path to the determined device; and
(iv) sending commands to cause a configuration where the selected intermediary device is configured as the path to the determined device and the at least one path to the determined device through at least one intermediary device other than the selected intermediary device is disabled.

20. The system of claim 19, wherein processing the generated discovery map to determine the devices to which there are redundant paths comprises determining duplicate instances of one address, wherein duplicate instances of one address indicate redundant paths through intermediary devices to one device.

21. A system coupled to a plurality of devices, including at least one end device and at least one intermediary device, comprising:
a circuit board; and
circuitry coupled to the circuit board capable of causing operations to be performed, the operations comprising:
(i) initiating a discovery operation to discover end devices and intermediary devices;
(ii) in response to discovering one device during the discovery operation, determining whether there are redundant paths to the discovered device;
(iii) selecting one intermediary device to provide one path to the discovered device in response to determining redundant paths to the discovered device; and
(iv) sending commands to cause a configuration where the selected intermediary device is configured to provide the path to the discovered device and the path to the discovered device other than through the selected intermediary device is disabled.

22. The system of claim 21, wherein the connected device comprises an end device or an intermediary device.

23. The system of claim 21, wherein the commands that cause the disabling of the at least one path through the at least one intermediary device other than the selected intermediary device further comprise:
determining at least one interface on the at least one intermediary device coupled to the path to the discovered device to disable; and
sending a command to disable the determined interface.

24. An article of manufacture in communication with end and intermediary devices, wherein the article of manufacture is capable of causing operations to be performed, the operations comprising:
initiating a discovery operation to discover end devices and intermediary devices;
in response to discovering one device during the discovery operation, determining whether there are redundant paths to the discovered device;
selecting one intermediary device to provide one path to the discovered device in response to determining redundant paths to the discovered device; and
sending commands to cause a configuration where the selected intermediary device is configured to provide the path to the discovered device and the path to the discovered device other than through the selected intermediary device is disabled.

25. The article of manufacture of claim 24, wherein the discovered device comprises an end device or an intermediary device.

26. The article of manufacture of claim 24, wherein the commands that cause the disabling of the at least one path further comprise:
determining at least one interface on the intermediary device providing the redundant path to disable; and
sending a command to disable the determined interface.

27. The article of manufacture of claim 26, wherein selecting one intermediary device comprises determining one interface in one intermediary device having a lowest device address.

28. The article of manufacture of claim 24, wherein determining whether there are redundant paths to the discovered device during the discovery operation comprises:
determining whether an address of the discovered device matches one address of a previously discovered device; and
adding information on the path through the selected intermediary device to the discovery device to a discovery map.

29. The article of manufacture of claim 24, wherein sending the commands to cause the configuration to disable the path to the discovered device comprises:
disabling at least one interface on the intermediary device providing the redundant path to disable that connects, to one corresponding interface on the discovered device.

30. The article of manufacture of claim 24, wherein sending the commands to cause the configuration to disable the discovered device comprises:
disabling at least one interface on the discovered device that connects to the intermediary device providing the redundant path to disable.

31. The article of manufacture of claim 24, wherein the devices comprise SAS devices, the intermediary devices comprise SAS expanders, and wherein redundant paths occur when there are multiple paths to a same SAS address in a same domain.

32. An article of manufacture in communication with end and intermediary devices, wherein the article of manufacture is capable of causing operations to be performed, the operations comprising:
generating a discovery map indicating end and intermediary devices discovered as accessible;
processing the generated discovery map to determine one or more devices to which there are redundant paths;
for each determined device to which there are redundant paths, selecting one intermediary device to provide one path to the determined device; and
sending commands to cause a configuration where the selected intermediary device is configured as the path to the determined device and the at least one path to the determined device through at least one intermediary device other than the selected intermediary device is disabled.

33. The article of manufacture of claim 32, wherein processing the generated discovery map to determine the devices to which there are redundant paths comprises determining duplicate instances of one address, wherein duplicate instances of one address indicate redundant paths through intermediary devices to one device.
